(19) United States
(12) Patent Application Publication
(10) Pub. No.: US 2011/0087975 A1
(43) Pub. Date: Apr. 14, 2011

(54) METHOD AND ARRANGEMENT IN A DATA

(75) Inventor: Peter KARSTEN, Old Windsor (GB)

(73) Assignee: Sony Ericsson Mobile Communications AB, Lund (SE)

(21) Appl. No.: 12/578,451

(22) Filed: Oct. 13, 2009

(51) Int. Cl. G06F 3/01; G06F 17/30

(52) U.S. Cl. 715/762; 707/812; 707/E17.044

(57) ABSTRACT

The invention relates to user equipment for recording data within the user equipment is provided. The user equipment includes a receiving unit to receive application data from a database within the user equipment, which application data is associated with at least one application. The user equipment further includes a monitoring unit arranged to monitor system data of the user equipment, which system data relates to an operation of the user equipment. The user equipment includes a recording unit arranged to record data in a source application of the user equipment, which recorded data includes the system data associated with the received application data.

### TECHNICAL FIELD

The present invention relates to the provision to and use of interactive applications in client devices such as user equipment (UE) within a mobile telephone network.

### BACKGROUND

There is limited real estate available in user equipments, such as mobile devices, for applications and advertising for service provision, and there is currently much interest from mobile telephone network operators and others in providing additional functionality and services to mobile telephone users other than simple voice and text messaging. Recent years have seen the rapid development of mobile telephony information services (e.g. news, travel and weather information) and entertainment services (e.g. games). It is appreciated that such services are especially rewarding (both for the user and the provider) when they are interactive, either with the content provider and/or with other users. However, despite the increasing sophistication of the UEs themselves (in terms of processing power, memory, storage and audio-visual abilities), the requirements for portability necessarily continue to place severe limits on the device capabilities when compared to non-portable computing and entertainment systems. Furthermore, the limited user interfaces continue to present service retail issues.

Any new system for providing information and entertainment to users of a mobile telephone network must address the above-mentioned limitations while also providing for a targeted, personalized, rich, interactive experience for the user, minimizing the amount of setup and pre-configuration required, and allowing for easy deployment of new features. Preferable, the time from concept to providing a service should also be reduced.

### SUMMARY

An embodiment of the invention provides a mechanism that enables provision of applications in a user terminal in a flexible and efficient manner.

According to a first aspect, a method is provided in a user equipment for recording data within the user equipment. The user equipment receives application data from a database within the user equipment, which application data is associated with at least one application. The user equipment monitors system data of the user equipment, which system data relates to an operation of the user equipment. The user equipment then records data in a source application of the user equipment, which recorded data comprises the system data associated with the received application data.

In some embodiments, the user equipment sends the recorded data to a source application within the user equipment, and uses the recorded data in the source application to set up a menu architecture in the user equipment.

Furthermore, the user equipment may receive second recorded data from a second user terminal from a database server. The user equipment then also uses the second recorded data in the application to set up the menu architecture in the user equipment.

In some embodiment, the user equipment sends the recorded data to a database server over the Internet.

In addition, the system data may be represented by navigation data, menu structure, impressions, time, date, temperature, GPS, vibration, accelerometer data, camera and/or the voice recognition. The application data may be represented by number of clicks, data amount transmitted, activation times.

In order to perform the method a user equipment for recording data within the user equipment is provided. The user equipment comprises a receiving unit arranged to receive application data from a database within the user equipment, which application data is associated with at least one application. The user equipment further comprises a monitoring unit arranged to monitor system data of the user equipment, which system data relates to an operation of the user equipment. The user equipment comprises a recording unit arranged to record data in a source application of the user equipment, which recorded data comprises the system data associated with the received application data.

The object is achieved according to a second aspect by providing a method in a database server for gathering data in the database server. The database server is comprised in a radio communications network. The database server receives recorded data over the Internet from a user equipment, which recorded data comprises system data associated with application data. The system data relates to an operation of the user equipment and the application data is associated with at least one application within the user equipment. The database server processes the recorded data for analyzing usage of the user equipment.

Additionally, the database server receives second recorded data from a second user equipment, and processes the recorded data and the second recorded data into analyzed data.

In some embodiments, the analyzed data or the processed data is transmitted to a source application in the user equipment or a different user equipment enabling the source application to set up a menu architecture in the user equipment based on the analyzed data or the processed data.

In order to perform the method a database server is provided for gathering data in the database server, which database server is comprised in a radio communications network. The database server comprises a receiving unit arranged to receive recorded data over the Internet from a user equipment, which recorded data comprises system data associated with application data, wherein the system data relates to an operation of the user equipment and the application data is associated with at least one application within the user equipment. The database server further comprises a processing unit arranged to

Hence, application may be provided in a user friendly and efficient manner by providing the recorded data indicating the application data associated with monitored system data.

### BRIEF DESCRIPTION OF THE DRAWINGS

Embodiments will now be described in more detail in relation to the enclosed drawings, in which:

FIG. 1 is a schematic diagram of a radio communications network;

FIG. 2 is a schematic diagram of a radio communications network;

FIG. 3 is a schematic diagram of a combined signaling and flowchart scheme;

FIG. 4 is a schematic diagram of a combined signaling and flowchart scheme;

FIG. 5 is a schematic block diagram of a radio communications network;

FIG. 6 is a schematic flowchart of a method in a user equipment;

FIG. 7 is a schematic block diagram of a user equipment;

FIG. 8 is a schematic flowchart of a method in a database server; and

FIG. 9 is a schematic block diagram of a database server.

### DETAILED DESCRIPTION

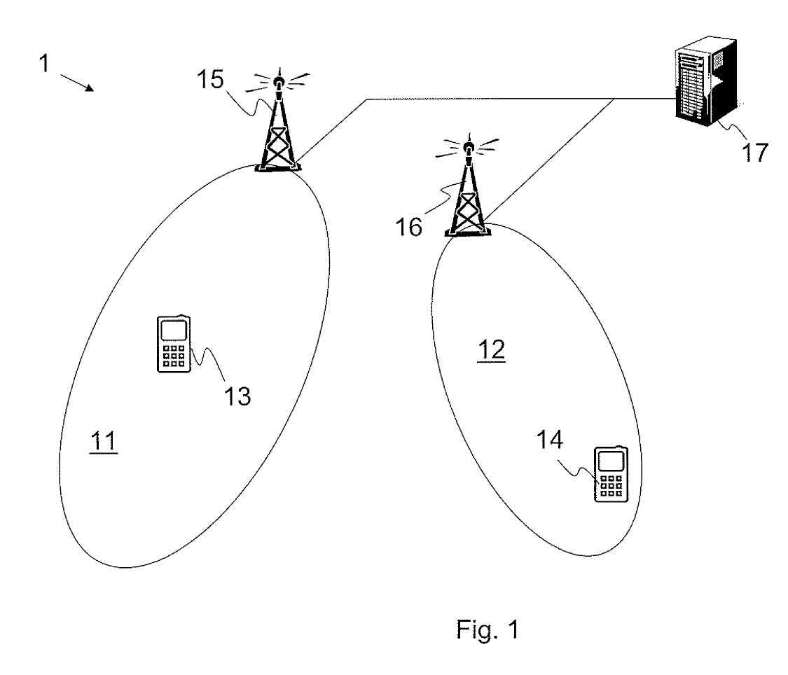

FIG. 1 shows an example of a telecommunications network 1 in which the present invention is suitably applied. As shown, the telecommunications network 1 is a cellular system and comprises a number of cells, two of which is shown as a first cell 11 and a second cell 12 in FIG. 1. Each cell may comprise a number of user terminals, with the generic name “UE”, User Equipment, two of which are shown as a first UE 13 and a second UE 14 in FIG. 1.

For each cell in the telecommunications network 1, there is a controlling node, generically referred to as a radio base station (RBS), two of which is shown as a first RBS 15 and a second RBS 16 in FIG. 1. One role of the RBSs 15,16 is that all traffic to and from the UEs 13 and 14 in the cells 11 and 12 is routed via the RBSs 15, 16. The telecommunications network 1 may comprise an LTE network as well as to other networks such as WCDMA, GSM or the like. The RBSs 15, 16 may be denoted as NodeB or eNodeB in some of the networks.

The RBSs 15, 16 is connected to a database server 17. The RBSs 15,16 may be connected to the database server 17 over an IP transmission line, such as over the Internet.

In embodiments herein the first UE 13 registers how the first UE 13 has been used in relation to an application stored within the first UE 13. A client portion of the user behavior may be encoded on a mobile telephone or PDA using a special-purpose XML language, which XML language also is used to connect to the database server 17 over the radio communications network 1. The information encoded according to the XML language is referred to herein as Database server Data, and typically describe what a user has done with the user terminal 13.

The Database server Data may, for example, describe the number of impressions of an application a user has been subjected to, the number of clicks on such applications, the actions taken within the application, the actions undertaken by the application, the location of the application within the UE, the geographical location of the UE at the time, the MS ISDN, and/or the UE type in question.

This Database server data may then be used to analyze applications and usage of such application in order to provide applications in a user terminal in a flexible and efficient manner.

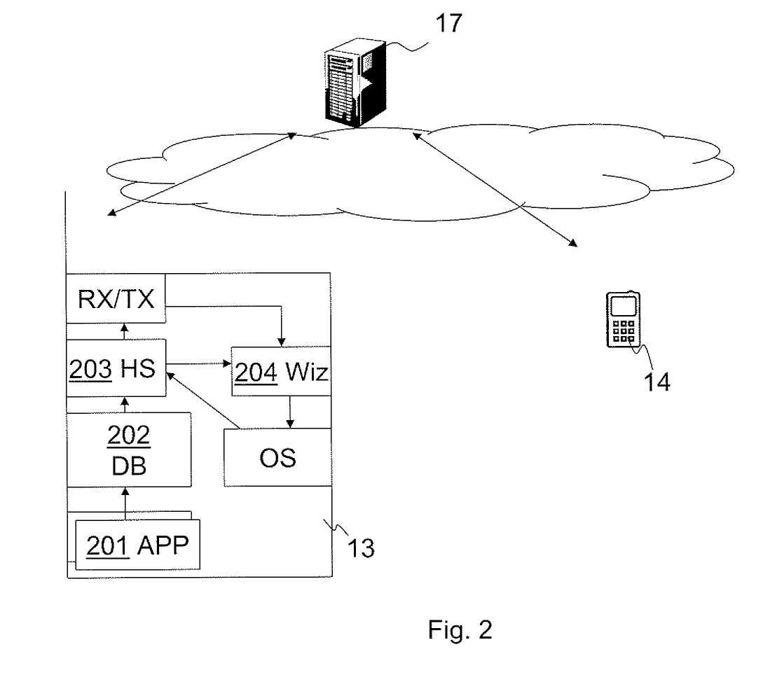

FIG. 2 is a schematic diagram of a radio communications network. The UE 13 comprises an application 201 and a database 202 that records application data of the application 201. The UE 13 further comprises a UE source application 203 arranged to record system data related to the usage of the UE 13. The system data is recorded associated with the application data of the application 201.

For example, the UE source application 203 may record how many times an icon of the application was shown to the user of the UE 13 in relation to how many times it was selected.

The recorded data in the UE source application 203 may be sent over a transcieving arrangement RX1TX to the database server 17. The database server 17 may store the received data related to the type of the UE 13 or the like. The database server 17 may receive other data from other UEs, for example, UE 14. The received data may be analyzed by an application at the database server 17.

Furthermore, the UE 13 may comprise a UE Wizard Wiz 204, wherein the WIZ 204 uses the recorded data to set up a menu architecture in the operating system OS of the UE 13. The WIZ 204 may also receive second recorded data from the UE 14 via the database server 17 and use the data to set up the menu architecture in the user equipment 13. Thus, the recorded data may be used to analyze behavior of the user of the UE 13 associated to the application 201 or to alter the menu architecture.

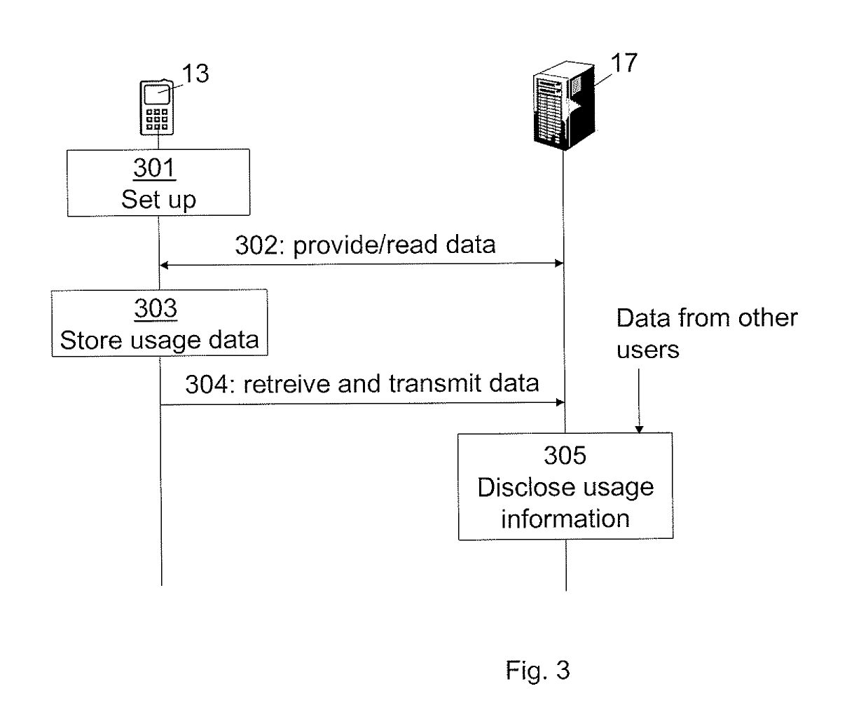

FIG. 3 is a schematic diagram depicting a combined method and signaling scheme. The method is illustrating an example of using embodiments disclosed herein a first time and to provide the service of a dynamical menu architecture.

### Step 301

The user of the UE 13 opens the UE 13 for the first time, straight and clean out of the box. Each UE 13 has factory default Server Data preloaded, and the pre-installed UE Source application 203 arranged to communicate with the Database server 17.

The Server Data is used to set menu item locations, including bookmarks and widgets. The user of the UE 13 starts a normal setup process, for example, chooses Optimized or Standard setup.

Optimized setup means that the UE 13 connects online to download application locations, applications, bookmarks, or widgets. Such download may be performed during configuration such as while the user inputs date/time/name into the UE 13, while UE 13 outputs Mobile Subscriber-International Service Directory Number (MS-ISDN) and inputs data, while the UE 13 outputs International Mobile Equipment Identity (IMEI), while the UE 13 outputs chosen language.

Standard setup means standard menu setup as set by default.

The user of the UE 13 may also choose a Dynamic or Fix menu functionality. Dynamic menu functionality means that the menu items are subject to server logic, for example; applications that have been used stay where they are; popular applications can crawl such as, if the customer migrates to the higher menu item, then the lower menu item is removed; if the customer does not use (or ceases to use) the application, the application is moved back down; additional menu items may automatically provided; or applications that have not been used after many impressions may be moved down or replaced, based on the individual user by using the Database server Data.

Fix menu functionality means that the applications stay as per the default.

This allows tracking the UE 13 and tracking a user independently of one another. Data protection issues may cause a requirement to hash the IMEI and/or MS-ISDN to enable the user to remain anonymous.

### Step 302

Each UE 13 has the pre-installed UE Source application 203 that pulls together enabled application data and provides the data to the database server 17.

Each time the UE 13 connects online, meaning whenever any application establishes a connection that can be used to connect to the database server 17, the UE 13 also provides its data and reads Server Data from the database server. The read server data then replaces the current Server Data of the UE 13. Connections include 2G/3G/WLAN and TCP/IP over Bluetooth.

Depending on how the UE 13 is set up, the menu item locations, including bookmarks and widgets, are updated to reflect new Server Data.

The user of the UE 13 may retrieve popularity rating data per applications so that the user may see which applications are popular. For example, an application may ask/state “Would you like to try an application everyone else loves?”; “Customers that used this application also used this one”. Popularity of many user is measured at the database server 17 using inputs such as the number impressions, clicks, connections and connection time, end-user rating, and how much users have paid to use a service.

### Step 303

Each enabled application of the UE 13 provides usage data, such as connection type and/or funnel data, which funnel data comprises indication whether the usage is a trial, light/full registration, or paid usage and common funnel elements are used where possible. The usage data is stored in the internal database of the UE 13.

### Step 304

The UE Source application 203 looks for data in the internal UE Database 202 and retrieves and transmits the data whenever a connection is present. The enabled services output data to the UE Database 202 whenever they have something to output. The UE Source application 203 has stored which applications are in the UE, as it tracks at least impressions and clicks on a per application level. It should be noted that a browser in the UE 13 may support browser related reporting such as bookmark impressions and clicks, which would mean that the browser need to support such reporting.

Each UE 13 may have an application that allows the user to see the user's own usage profile compared to other users of the UE 13 in question or differs from average usage.

### Step 305

The information received and stored on the database server 17 will be able to disclose the relative application popularity, cost of customer acquisition per application based on the value of the real estate where the clicks were sourced, and value per deployed application and/or the like.

Hence, this lightweight deployment model enables beta versions of services to be made public for the market to decide which deserve to be scaled and developed further—or quietly retired based on the information stored in the database server 17.

The database server 17 provides data that can be viewed to provide information about performance by UE, application, application suite, data usage and more. The view includes data from external sources such competitor UE data.

The provided information may be used to respond to “How much data will users use?”, “How many apps and services will be bought?”, “What pricing sensitivity has been seen elsewhere?”, and to choose applications based on revenue and usage, Accept services that are popular but yield no added revenue, choose among services based on revenue potential, opportunity to try local services within quantitative framework.

Online and scheduled visibility for network operators may be limited to anonymous statistical information unless a closer cooperation occurs. The launch reporting will be scheduled and pre-canned, with Business Intelligence views of the data enabled step-by-step at later stages.

The Network Operator views may have the option of including only subsets of the data, such as only the related network operator's data from a limited group of UEs or applications. Network Operators that do not wish to allow their data to be shown even for statistical purposes to other network operators may optionally tick out of enabling their customers' data from being shown in such manner.

The embodiments herein also allow tailoring to specific network operator needs, such as loading specific types of data into a network operator's Customer Relationship Management (CRM) systems, again subject to Data Protection.

Online users may be monetized. Such as, the right menu item in the right place at the right time and visibility of probable future revenues.

In some embodiments a Tariff Composer component of the network operator view is a web mash-up application that enables a network operator to matrix network operator tariffs with expected customer behavior to view projected revenue streams.

Each UE 13 may be presented with forecasted GPRS usage levels based on data from the same or similar UE types with same or similar applications, bookmarks and widgets loaded. This forecast allows revenue and data usage forecasting, and also allows correlation between high resolution cameras and GPRS usage to be established.

UEs with accurately forecasted results represent higher net present value for the network operator due to the lower risk.

Online connectivity for each service (2G/3G/WLAN/SMS) may be tracked separately for each service.

Each service/application provided using the UE 13 has a combination of potential revenue and cost associated with it, beyond the related GPRS traffic related costs and revenues. Embodiments herein aim to provide data on revenues and costs for services for network operators, so that network operators may estimate potential service level revenues and benchmark revenues against other markets. The services offered may be a combination of services recommended by a UE provider and operator services. The goal may be to achieve data on Cost of Acquisition (CPA), Lifetime Value (LTV) and Return on Investment (ROI) on a per service level, and make it possible to view effects of multiple services being bundled in different ways.

The revenues may be based on: Subscription as part of a bundle or an added service, Pay-as-you go service access, Purchases from the service.

The costs may be based on; Impressions needed for clicks to occur, use needed prior to converting the customer to a paying customer, Music and celebrity services have media rights management costs, Services such as online game participation have access/usage costs, Download services have per download costs.

The costs are increased if the wrong set of applications is in place at the wrong time, and if the pricing is inaccurate.

Embodiments herein provide data that may be viewed to provide information about performance by phone, application, application suite, data usage and more.

It should also be understood that the user wants the right suite of Services/applications of the UE 13. The applications should be located in right places at

the right time. A starting point may be based on the information known about the customer at the time in light of data that may be available from the related network operator.

Exemplary information may be that “the user has this type of UE.

As more information is gathered anonymously or not, there is an opportunity to adapt the user interface dynamically. The customer may see which applications are most popular, and compare to own usage as stated above. The customer may receive tips such as “Would you like to use a picture to send a Valentine's card?” and “Customers that played this game also downloaded that game”. These messages will be configurable to enable A/B testing.

As application in general takes up much smaller memory space than for example media data more bookmarks, widgets, and applications than fit on the user interface are preloaded in the UE. There is a default starting menu architecture for each new UE but if a bookmark, widget or application is not used after a number of impressions, it may be moved to a less attractive location or be (temporarily) removed from the user interface. New bookmarks, widgets, and applications may be loaded from the UE 13 or network to replace removed items.

User behavior is monitored to capture information that may be used to further optimize the user interface.

The user has the option to select a behavioral profile such as “Entertainment” in the evenings to morph the user interface or to themes for Valentines Day on Valentines Day.

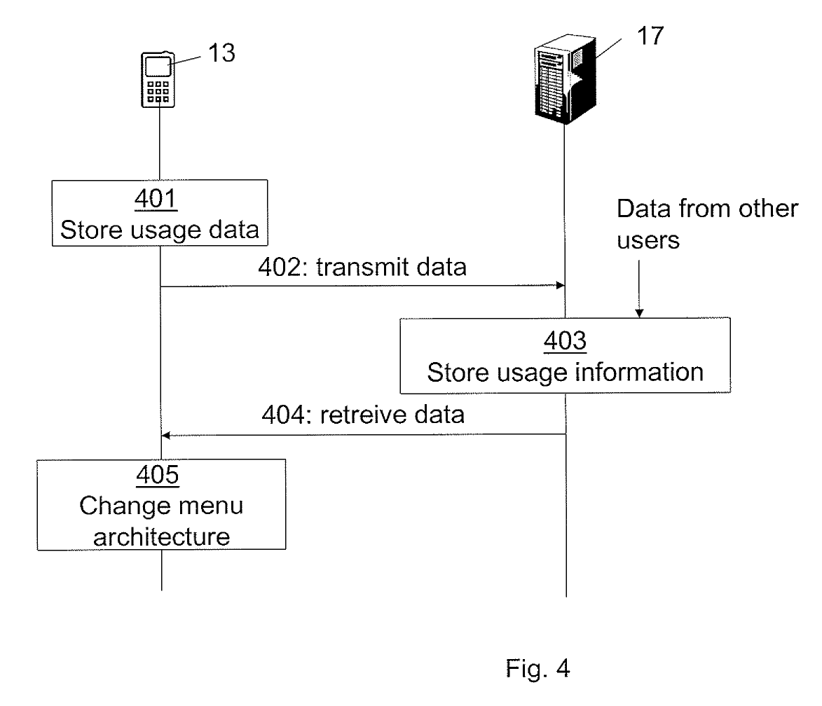

FIG. 4 is a combined signaling and flowchart of a method in a radio communications network enabling a dynamical menu architecture.

### Step 401

The UE 13 stores usage data such as impressions of an application as well as number of times the application was clicked on. The usage data comprises application data and system data relating to the operation of the UE 13.

### Step 402

The UE 13 transmits the stored usage data to the database server 17.

### Step 403

The database server 17 receives usage data of the UE 13 and other UEs and also stores the received usage data.

### Step 404

The UE 13 retrieves the usage data from the database server 17.

### Step 405

The UE 13 uses the retrieved usage data to change the menu architecture. For example, the most used application of the users of a certain type of UE is retrieved and displayed in the start-up menu.

There is scope to make it easier for a network operator to accurately predict revenue potential. For example, at the network level, value of bit pipe for UE's average customer; at the application level, value of applications, widgets, and links, for example Quantitative methods to generate basis for feature selection.

By analyzing how much revenue can be obtained for various applications, widgets and bookmarks depending on their location in the UE, it will be possible for network operators to set “location pricing” for every location in the UE.

Location pricing enables network operators more accurately to Increase UE pricing by placing prime revenue driving applications in locations with the highest location pricing, hence maximizing the revenue potential data rich applications services with strong reasons to go online now.

No need to offer discount for not knowing whether UEs will yield network revenues.

Lower UE BOM cost by charging 3rd party content providers for including their content. Network Operators will be in a strong position to charge 3rd party providers at the right level, based on knowledge about: Location pricing, Expected impressions and click through rates for such locations, How much traffic each application generates after the first click, An understanding of how traffic relates to 3rd party service provider revenues on a per application basis, And hence approximately what magnitude of value each location has for a 3rd party content provider.

Cost per Acquisition (CPA) can be reduced by leveraging existing registration data and cross-selling. This can be achieved both at a network operator level, where database server 17 is integrated with network operator pre-authenticated customer databases, and within the database server 17 by leveraging the first registration data across all services with implemented function.

Each service will have its own CPA, and each UE will have a blended CPA for the UE. This will yield data on customer appetite and behavior based on many parameters—such as UE, service suite, time, location and data use.

The Lifetime Value (LTV) for each service can also be viewed as a blended LTV and then associated with the blended CPA to achieve ROI calculations. Such core calculations shall be automated and real time, and allow indexing per UE, country, and customer profile.

A/B testing will be enabled by preloading more applications than are shown at any given point in time, and cycling applications through the user interface under server control/knowledge.

Embodiments herein will deliver Lifetime Value (LTV) instead of a revenue share for app sales from a non-network app store. Deliver Lifetime Value (LTV) for the whole UE is provided herein, Leverage operators strong wap portal position, which for example shows 37.10% of all August 2009 Live! hits coming from a certain manufacturers UEs.

The focus on the Lifetime Value (LTV) of every application and service, combined with the traffic level revenues, gives a total image of the value of the services to the network operator.

Also embodiments herein enables application developers that provide applications that support the present Interface and/or the database server Interface may see the performance of their applications in real time.

By using application tracking, a client developer may see:

Impressions

Clicks

Data by country (shows country index on an application level)

Accept Terms and Conditions

Use locally

Use online

Light registrations

Full registrations

Payments

Repeat payments

Upgrade payments

These views can be tracked and seen on a per deployment basis.

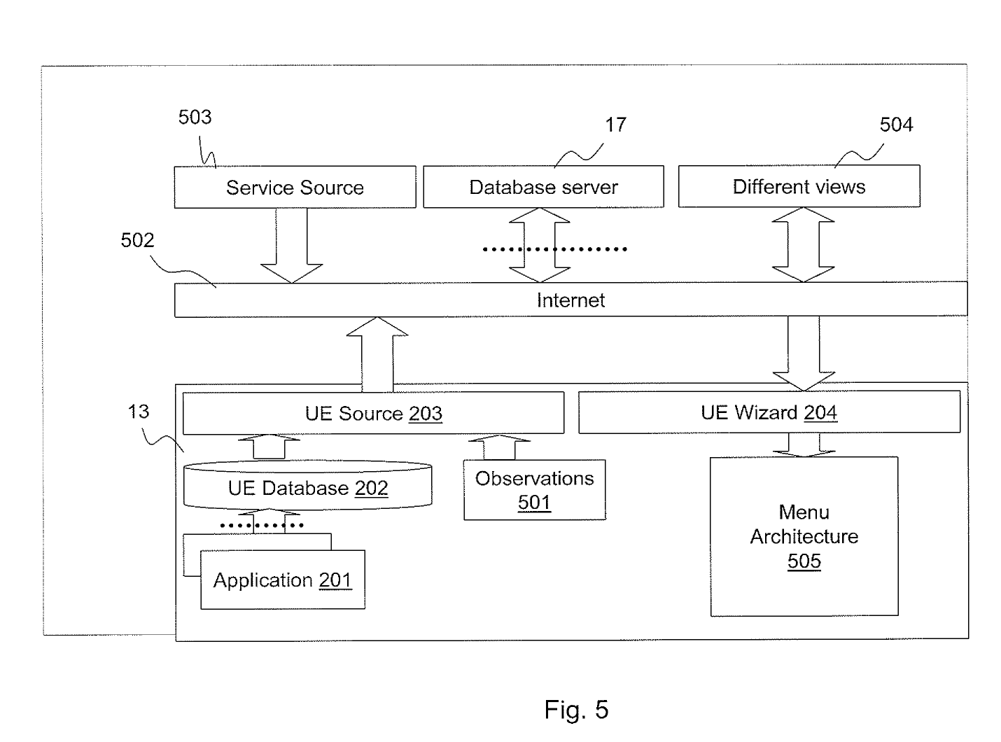

In FIG. 5 a schematic diagram of a radio communications network is shown. Each UE 13 comprises the UE Source application 203 that automatically sends data from the UE 13 to the database server 17.

A Service Source 503 is a generalized term for sources of service data that are not UE based. Some services are built using browsers and widgets, and where possible these shall be a Service Source that tracks, stores usage of services and associated data to such service by either:
Going through a proxy server for automated traffic analysis; or
Reporting server data to the Database server without UE involvement.

The UE Source 203 retrieves data from:
The UE Database 202, a database in the UE which is populated by data from each application 201 that is database server 17 enabled.

Data will be moved from the UE Database 202 to the database server 17 to prevent taking up too much memory.
System data 501 from observations such as software version, time and place, phone numbers that are preloaded by the network operator, to analyse how often each number is called and provide value estimations for such preloading, usage or the like.

The general operations of the radio communications network may comprise: UE Source 203 monitors clicks, impressions, and system Data to report over the Internet 502 to the database server 17;
applications 201 in the UE 13 report to the UE Database 202;
Service Source 501 is a proxy through which preloaded widgets connect to feeds, and reports traffic, for example, browser history which the UE 13 visits in relation to a certain site to the database server 17;
database server 17 collects data from the UE Source 203 and Service Source 503, and makes data available for analysis in different views 504;
Existing UE applications 201 continue separately or become database server 17 enabled; different views 504 can be viewed by sales team, network operator and product management, a UE Composer enables modelling of new UE configurations;
UE Wizard 204 collects data from database server 17 and optimises a menu architecture 505, that is, the user interface.

If the user terminates an application without giving the application an opportunity to send its usage data, or if the absence of connectivity and/or UE Database causes an application to not be able to send data at the end of use, the application will store the usage data in itself and make that data available next time the application is used. There may be several uses until the data can be sent.

Connectivity may be provided by http and/or sockets—decision not yet taken.

Any and all data in the database server 17 is called Server Data, and is made available on a secure private cloud basis. The secure transport mechanism will be decided in due course.

The Operator View, Sales View, and UE Composer are a web based mash-up user interfaces that use Server Data and other feeds to provide views and links.

The Operator View can integrate network operator Customer Relationship

management (CRM) functionality or offer own CRM functionality on a private cloud basis. Resulting CRM response data can be used.

The UE Composer allows UE product managers to predict what results will be achieved with various sets of applications.

The impact of opening new UE sales channels can be monitored in real time.

The UE Wizard 204 is a UE application that retrieves Server Data to drive aspects of the user interface:

Optimization

Dynamic menu items

Ranking data for a more fun/functional user interface

Display/hide, move/crawl

Download

The service will be highly resilient and scalable, and provide the means to redeploy new releases of the server components with minimal disruption to the service. All database server components must be upgradeable with minimal downtime.

The Database server Project will deliver interfaces that can be provided to in-house and 3rd party application developers.

Just like any roadmap with many features, database server 17 needs to be self-expanding in the sense that each dimension is increased independently.

Each of the following will be made step-by-step more compatible with Database server:

Each application will increasingly:
Collect and store usage information
Be made network centric

Each UE will increasingly:
Pull together collected and stored application data
Collect and store UE information
   Types of networks used
   Application locations
   As much user info as the terms and conditions combined with Data
   Protection Acts allow
   Be made network centric

The system is self-monitored and automated, and automatically provides reports and warning flags regarding deployment, customer exposure, usage, revenues.

The product manager will be able to compose new UEs based on quantitative data about expected usage levels and revenue potentials in a UE composer application with data collected in the database server 17.

The applications should increasingly be built to allow themselves to be composed. This means a requirement for simple, clear functions and well-documented Application programming interfaces APIs. Applications in the phone need to become Application Sources, so that they can feed data via the UE Source to the Database Server.

The steps for an application are:
Create an application specific database
This database shows usage data and is in a Database server format, and is designed and managed such that it does not expand excessively and consume too much memory
Store the database in a pre-defined phone location—the Database server folder
Populate its database when used
Make its database richer step-by-step, each date stamped
   Clicks
   Accept terms and conditions
   Trial
   Uses (uses are more than trials for good applications)
   Uses locally, meaning proper use but no online activity
   Uses online, such as saving data or accessing services
   Data use as seen by application
   Data use split by connection (2G/3G/WLAN).

The UE source 203 is an application in the UE 13 that:
Monitors all menu navigation to record and store navigation data such as impressions in the folder.
Provides all the databases in the folder to the server, the memory management features that prevent running out of memory, and maintains the database server 17 and UE Database 202 in synchronization.
Provides data to the UE Database 202 so that the UE Wizard 204 has a local repository from which it can read, as well as database server.

Database server 17 receives data from the deployed UE sources of different UEs and makes these available in a single database for analysis. The database server 17 may use online currency conversion facilities, e.g. oanda.com, to provide cross-currency data collation support. The database server 17 may make the data available securely with a well-documented API:
Usage data for statistical purposes,
Customer registration data for scenarios that require these to be made available, such as 3rd party applications where the customer registers with the third party and the server is used only as a conduit for data.

The UE Composer enables a product manager to build simulations based on assumptions regarding deployment, and calculate the revenue potentials in various scenarios.

The UE wizard 204 enables a product manager to automatically optimize application choice and locations within a menu structure based on framework assumptions such as country, UE menu architecture, and target market segment (e.g. prepaid or post-paid).

There is an opportunity to open the server interface to enable 3rd party services to benefit from reporting, if it is in manufacturer's interest to compare 3rd party services within the framework. Such services may also be deployed on 3rd party UEs such as iPhones.

Observable Driven User Interface

An additional goal is to allow arbitrary system data also called observables drive the user interface.

Observables are arbitrary system data inputs, such as:
Phone calls and messaging
   Characteristics, such as the identity of a caller
   Contents, such as the message size or photograph inclusion
   Voice recognition use for keywords
Key press sequences
   Camera input
   Phone movement and/or vibration
   Temperature
   Time
   Location.

Such observables are provided input to the UE Database 202, and provide a part of the basis for configuring the user interface.

For example, strong light into the camera may be used as the trigger for the phone to enter outdoor mode, or a high sound level may cause the phone to exit silent mode.

Another example could be to minimize the user interface when subjected to repeated movement (if you run, you do not need all functions and a menu architecture of displaying merely the media player in the top menu. This may be based on recorded application data and observable (movement of the phone).

Such information can also be used as a basis for marketing.

Registration using any of the applications gives registration for all applications. The registration process is designed such that integration with network operator databases is possible.

This close link with network operators, combined with CPA/LTV/ROI focus, means close alignment with network operator thinking, and differs from the “sell-and-forget” application sales and subsequent revenue sharing.

The registration flow may be structured in five steps:
Light registration
   IMEI automatically used
   MS-ISDN automatically used
   Username as selected by customer if needed for application
Full registration
   Age verification
   KYC for payment purposes
Payment
   The customer has made at least one payment
   The required payment methods have not yet been defined
Repeat payment
   The number of payments made
Upgrades
   The number of service upgrades the customer has paid for

Referring back to FIG. 5, the system may comprise a number of elements.

Application 201

Application 201 in the UE 13 that either do not support database server 17 (legacy) or do support database server 17 by providing usage data to the UE Database 202.

Application Source 203

UE application that outputs data to the database server 17

Database Server Client Application

An application on the UE that supports the Database server Client Interface

Database Server Client Interface

the interface between the database server Client Application and the combined UE Database and UE Source 203.

Database Server 17

Server that holds all data related to this service, and makes such data available for the Operator View, Sales View, UE Composer, and UE Wizard.

Database Server Application

An application on the Database server 17 that supports the Database server Interface.

Database Server Interface

the interface between the Database server and any application seeking to provide or access data to the Database server.

UE Composer

Web application that enables UE product management to analyse expected effects of applications, bookmarks, and widgets on traffic and service revenues.

UE Database 202

Database in the UE 13 that collect data from UE applications 201.

UE Source 203

Application that collects usage data (impressions and clicks), retrieves data from the UE Database and sends all resulting data to the Database server.

UE Wizard 204

Collects data from the Database server 17 and optimizes the user interface. May also collect new applications, bookmarks, and widgets online in the future.

Operator View

Web mash up that allows a network operator to view expected revenues in their target market(s) for UEs in terms of GPRS usage and service level revenues.

Sales View

Web mash up that allows sales team to view UE packages from a traffic and service revenue potential perspective.

Server Data

The data held by the Database server 17

Service Source

Proxy through which widgets and streaming media applications connect to their respective servers. Provides further usage data to the Database server.

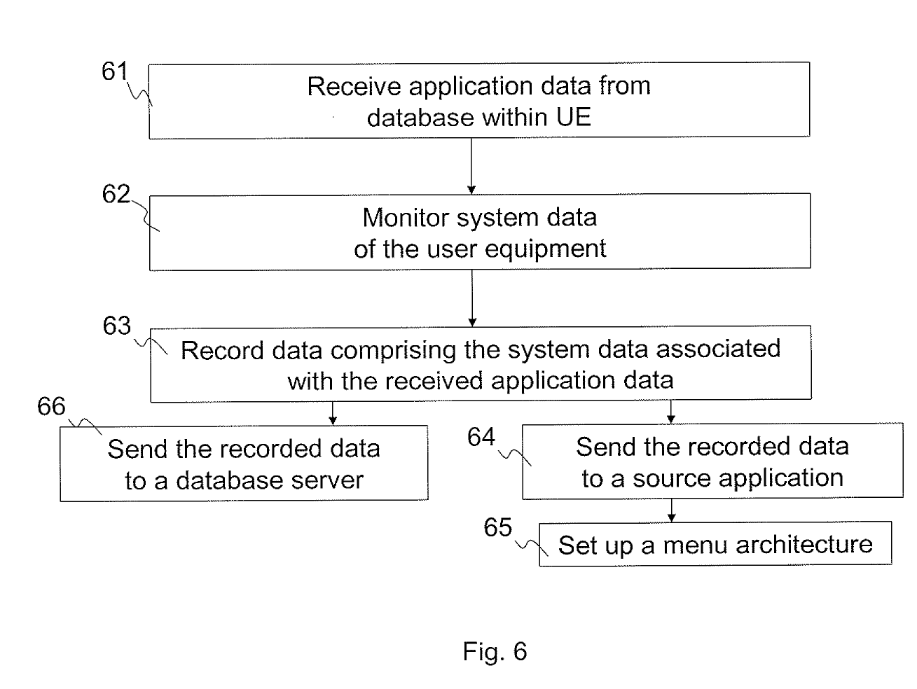

The method steps in the user equipment, referred to as UE 13 in the figures, for recording data within the user equipment 13 according to some general embodiments will now be described with reference to a flowchart depicted in FIG. 6. The steps do not have

Step 61

The user equipment receives application data from a database within the user equipment, which application data is associated with at least one application. The application data may be represented by number of clicks, data amount transmitted, activation times and/or the like.

Step 62

The user equipment 13 monitors system data of the user equipment 13, which system data relates to an operation of the user equipment 13. The system data may be represented by navigation data, menu structure, impressions, time, date, temperature, GPS, vibration, accelerometer data, camera and/or the voice recognition.

Step 63

The user equipment 13 records data in a source application of the user equipment 13, which recorded data comprises the system data associated with the received application data.

Step 64

This is an optional step. The user equipment 13 sends the recorded data to a source application within the user equipment 13.

Step 65

This is an optional step. The user equipment 13 uses the recorded data in the source application to set up a menu architecture in the user equipment. The user equipment 13 may further receive second recorded data from a second user terminal from a database server. Hence, the step of using the recorded data also uses the second recorded data in the application to set up the menu architecture in the user equipment.

Step 66

This is an optional step. The user equipment may send the recorded data to a database server over the Internet. This may be performed as an alternative of the step 64 or be performed as well as step 64.

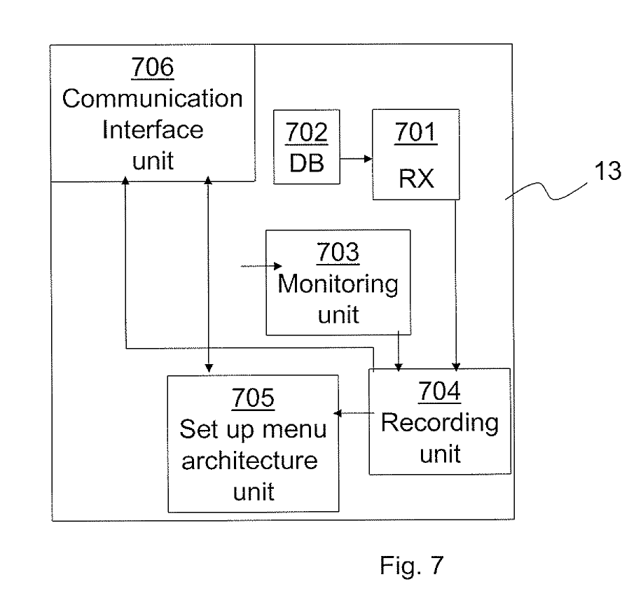

In order to perform the method a user equipment is provided. The user equipment is schematically shown in FIG. 7.

The user equipment 13 is for recording data within the user equipment 13. The user equipment 13 comprises a receiving unit 701 arranged to receive application data from a database 702 within the user equipment 13, which application data is associated with at least one application. The user equipment 13 further comprises a monitoring unit 703 arranged to monitor system data of the user equipment, which system data relates to an operation of the user equipment. The user equipment also comprises a recording unit 704 arranged to record data in a source application of the user equipment, which recorded data comprises the system data associated with the received application data.

The user equipment may comprise a menu architecture unit 705 arranged to set up a menu architecture in the user equipment based on the recorded data in the source application. This set up may also be based on received, over a communication interface 706, recorded data from the database server 17 or a second user equipment. The user equipment may comprise over the communication interface 706 arranged to send the recorded data to the database server 17 over the Internet.

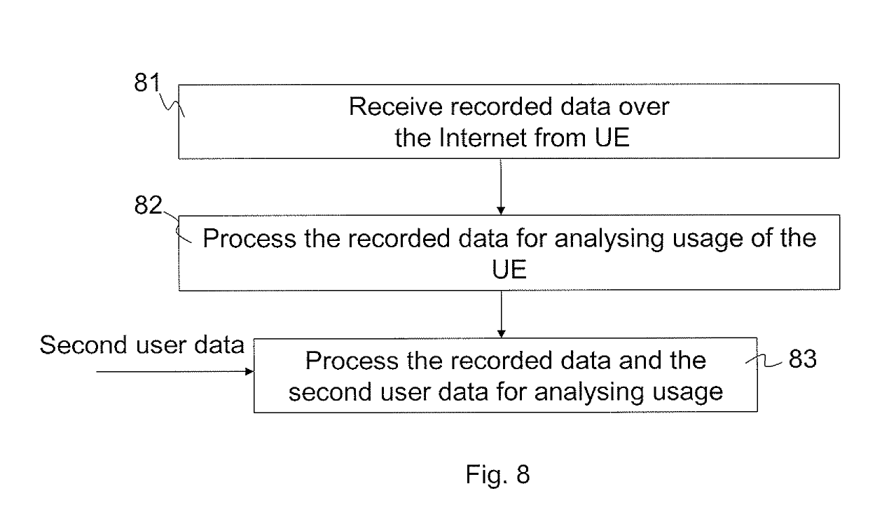

The method steps in the database server 17 for gathering data in the database server 17 according to some general embodiments will now be described with reference to a flowchart depicted in FIG. 8. The steps do not have to be taken in the order stated below, but may be taken in any suitable order. The database server 17 is comprised in a radio communications network.

Step 81

The database server 17 receives recorded data over the Internet from the user 15 equipment 13. The recorded data comprises system data associated with application data, wherein the system data relates to an operation of the user equipment and the application data is associated with at least one application within the user equipment 13.

Step 82

The database server 17 processes the recorded data for analyzing usage of the user equipment 13. The database server 17 may also receive second recorded data from a second user equipment.

Step 83

This is an optional step. The database server 17 processes the recorded data and the second recorded data into analyzed data. The analyzed data or the processed data is transmitted to a source application in the user equipment 13 or a different user equipment enabling the source application to set up a menu architecture in the user equipment 13 based on the analyzed data or the processed data.

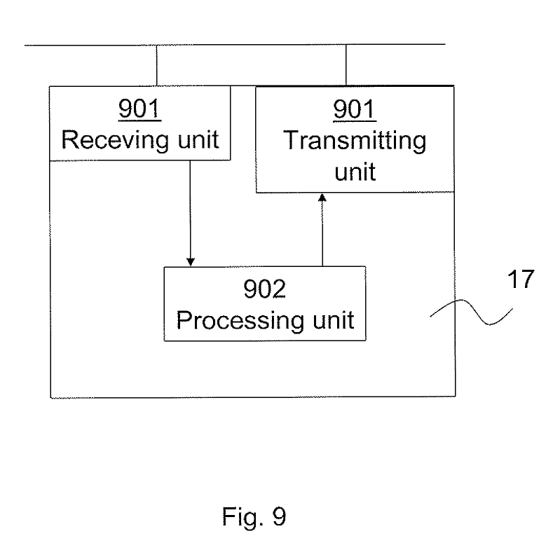

In order to perform the method a database server is provided shown schematically in FIG. 9. The database server is for gathering data in the database server, which database server is comprised in a radio communications network. The database server 17 comprises a receiving unit 901 arranged to receive recorded data over the Internet from a user equipment, which recorded data comprises system data associated with application data, wherein the system data relates to an operation of the user equipment and the application data is associated with at least one application within the user equipment. The database server further comprises a processing unit 902 arranged to process the recorded data for analyzing usage of the user equipment. The processing unit 902 may also receive second recorded data from a second user equipment and processes the recorded data and the second recorded data into analyzed data. The analyzed data or the processed data is transmitted over a transmitting unit 903 to a source application in the user equipment 13 or a different user equipment enabling the source application to set up a menu architecture in the user equipment 13 based on the analyzed data or the processed data.

It is herein disclosed: To preload a UE Database with usage statistics from a pool of users, and using such statistics to drive the user interface; To send and/or receive usage statistics in parallel with other data when connecting online; To enable an application that connects to the internet to extract statistical information from the UE and send such data in parallel with other online communications; To install more applications and links to applications than the user interface supports, and use the UE Database as the guide for which applications and links should be presented to the user; To install more applications and links to applications than the user interface supports, and use the Server Database as the guide for which applications and links should be presented to the user; To cycle applications and links through various parts of the user interface, measuring the efficacy of such applications and links in such locations, and allowing the resulting data to guide subsequent user interfaces; To use the Sewer Database and/or the UE Database to drive downloads of applications and links to applications; To download a menu architecture in parallel with providing tasks such as registration to the user; To allow the menu architecture and the locations of applications and/or links to applications to be driven by the Server Database and/or UE Database; To enable data related to a specific user to be reused when changing UE—meaning that the Server Database remembers the users behavior as captured in a UE Database, and the Server Database then being used to populate a subsequent UE Database; To use a Server Database as a basis for suggesting which future UE a user could acquire (basis for recommendations); To output statistical user behavior data only using preselected interfaces, such as only on WLAN connections; To only receive statistical user behavior data using preselected interfaces, such as only on WLAN connections; To use the UE Database and Server Database to dynamically compare a users behavior with segments of other users behavior and present the result to the user; To use the click-to-impression ratio as a basis for locating applications and links to applications within a UE;

To automatically delete applications and links to applications that under perform based on UE Database and/or Sewer Database data; To adapt the menu architecture based on a users navigation of the menu; To centralise user registration status and data for shared use by several applications in one UE; To use user registration data as the basis for driving the user interface (e.g. expanding the user interface or showing 18+ services to only certain users) To dynamically set the user interface based on Server Data, UE Data, and a tariff package provided by a network operator; To associate application behavior with user tariffs, for example, a flat rate GPRS user may wish to send a photograph and not be offered a low resolution option;

To associate menu structures and menu items with user tariffs, for example, a prepaid user known to be under-16 may be offered entertainment oriented services that require minimal GPRS usage when sending, and a variable rate GPRS user may be offered a choice of full resolution or low resolution sending; To store usage data in a UE application until it is possible to send it, even though the application itself may be terminated from time to time; To only send data from an application and/or UE Database if a suitable connection is available, such as WLAN; To use multiple databases in a UE to collect data prior to sending such data to a server (e.g. applications have their databases, and the UE Database); To mark data items in a multiple database architecture such that only the most relevant data item is sent when connecting; To use the UE Database as the Server Database, meaning to allow peer-to-peer connectivity with no or minimal server interaction to achieve data collection; To synchronize usage data in multiple UEs with or without server interaction; To use UE Database and/or Sewer Database data in conjunction with tariff information to set or suggest suitable tariffs; To use UE Databases in a peer-to-peer environment to suggest suitable tariffs (e.g. “You and I have similar usage, and I have this tariff package from my network operator. Let's compare and see which one is most efficient”); To automatically change tariff based on forecast usage To create clusters of similar users and use such clusters to increase buying power in relation to a network operator and/or UE provider; To create clusters of users and propose UE upgrade paths; To create clusters of users and propose UE upgrade paths based on tariff information such as when contracts expire or UE information such as “old UEs”;

To use Server Database and/or UE Database data to enable users to be reference customers for other users (e.g. if a user has the next generation UE and a similar usage pattern, then such a user can make himself available to users of older UEs as a reference as a part of a marketing drive); To use Server Database and/or UE Database data as a basis for incentivizing users to promote network operator, UE provider and/or service provider services; To create clusters of Server Databases and/or UE Databases based on contact data stored by the user in the UE or elsewhere to provide marketing to whole or parts of such clusters; To use arbitrary stored data in a UE in conjunction with UE Database and/or Server Database data as a basis for marketing; To use the location observable to suggest tariffs and/or UEs and/or UE features; To use the UE Database and/or Server Database in conjunction with tariff information to predict bill shock and prevent churn; To use Observables such as location to drive application behavior, such as providing radio channels automatically only in certain jurisdictions as driven by rights management requirements; To use Observables such as voice recognition with keyword recognition to create the basis for marketing (e.g. Google Mail, where Google looks at the contents of email to provide context sensitive marketing); To use dynamically collected usage data in association with tariff plans to automatically forecast revenue levels; To predict revenue potential by using quantitative usage data collected for customer segments in conjunction with network operator tariff plans and foreseen new UEs; To use application specific usage databases in UEs as a means of collecting usage data; To use a UE application that automatically monitors user behaviour for statistical purposes; To have a standardized multi-application funnel that tracks usage depth in a comparable manner (click, use, light registration, full registration, payment) within a UE; To use a standardized multi-application funnel that tracks usage depth in a comparable manner (click, use, light registration, full registration, payment) within a UE such that the deepest funnel penetration is made available to all related applications and services (e.g. If the user has performed light registration in one application, such light registration detail is made available for all other applications and services).

In the drawings and specification, there have been disclosed exemplary embodiments of the invention. However, many variations and modifications can be made to these embodiments without substantially departing from the principles of the present invention. Accordingly, although specific terms are employed, they are used in a generic and descriptive sense only and not for purposes of limitation, the scope of the invention being defined by the following claims.

What is claimed is:

1. A method, performed by user equipment, for recording data within the user equipment
comprising:
receiving application data from a database within the user equipment, which application data is associated with at least one application;
monitoring system data of the user equipment, which system data relates to an operation of the user equipment; and
recording data in a source application of the user equipment, which recorded data comprises the system data associated with the received application data.

2. A method according to claim 1, further comprising:
sending the recorded data to a source application within the user equipment; and
using the recorded data in the source application to set up a menu architecture in the user equipment.

3. A method according to claim 2, further comprising:
receiving second recorded data from a second user terminal from a database server, wherein the step of using the recorded data also uses the second recorded data in the application to set up the menu architecture in the user equipment.

4. A method according to claim 1, further comprising:
sending the recorded data to a database server over the Internet.

5. A method according to claim 1, where the system data is represented by navigation data, menu structure, impressions, time, date, temperature, GPS, vibration, accelerometer data, camera and/or the voice recognition.

6. A method according to claim 1, where the application data is represented by number of clicks, data amount transmitted, activation times.

7. A method in a database server for gathering data in the database server, which database server resides in a radio communications network, comprising:
receiving recorded data over the Internet from a user equipment, which recorded data comprises system data associated with application data, wherein the system data relates to an operation of the user equipment and the application data is associated with at least one application within the user equipment; and
processing the recorded data for analyzing usage of the user equipment.

8. A method according to claim 7, further comprising:
receiving second recorded data from a second user equipment; and
processing the recorded data and the second recorded data into analyzed data.

9. A method according to any of the claims 7, where the analyzed data or the processed data is transmitted to a source application in the user equipment or different user equipment enabling the source application to set up a menu architecture in the user equipment based on the analyzed data or the processed data.

10. User equipment for recording data, comprising:
a receiving unit arranged to receive application data from a database within the user equipment, which application data is associated with at least one application;
a monitoring unit arranged to monitor system data of the user equipment, which system data relates to an operation of the user equipment; and
a recording unit arranged to record data in a source application of the user equipment, which recorded data comprises the system data associated with the received application data.

11. A database server for gathering data in the database server, which database server resides in a radio communications network and comprises:
a receiving unit arranged to receive recorded data over the Internet from user equipment, which recorded data comprises system data associated with application data, where the system data relates to an operation of the user equipment and the application data is associated with at least one application within the user equipment; and
a processing unit arranged to process the recorded data for analyzing usage of the user equipment.
